(19) United States
(12) Patent Application Publication
(10) Pub. No.: US 2026/0016294 A1
(43) Pub. Date: Jan. 15, 2026

(54) A COLLISION PROTECTION APPARATUS

(71) Applicant: Taylor Hobson Limited, Leicester (GB)

(72) Inventor: Calvin WAN, Leicester (GB)

(21) Appl. No.: 18/994,153

(22) PCT Filed: Jul. 17, 2023
(86) PCT No.: PCT/GB2023/051871

§ 371 Date: Jan. 14, 2025

(30) Foreign Application Priority Data
Jul. 15, 2022 (GB) 2210471.5

(51) Int. Cl. G01B 21/04; G01B 5/008

(52) U.S. Cl. CPC G01B 21/047; G01B 5/008

(57) ABSTRACT

An aspect of the invention provides a method of controlling a measurement instrument (100; 200) for avoiding collisions between the measurement instrument and a component (190; 290) to be measured, wherein the measurement instrument comprises a rotatable mounting (120; 220) for rotating a component (190; 290) for measurement, the measurement instrument (100) is configured to control the measurement probe (160; 260) to perform a surface measurement of the component (190; 290) as the component rotates on the rotatable mounting (120; 220) and the measurement probe moves relative to the component at a movement speed, the method comprising: obtaining a first distance signal from a first distance sensor wherein the first distance signal is indicative of the distance between the component and the first distance sensor; defining a first threshold region around the component based on the first distance signal; reducing the movement speed to a first movement speed in the event that the measurement probe is within the first threshold region.

### FIELD OF INVENTION

The present invention is directed to the field of measurement instruments, in particular, roundness measurement instruments and optical profilometers.

### BACKGROUND

For many manufactured products and components it is important that surface characteristics such as form and shape are within defined tolerances. Metrological instruments (also referred to as measurement instruments) are known which measure such surface characteristics for quality control purposes. These metrological instruments must be manufactured to a high precision in order to minimise the effect of systematic errors introduced by the metrological instrument on measurement readings.

Collisions between measurement instruments and components to be measured by the measurement instruments are disadvantageous namely because the measurement instrument and/or the component can be damaged in said collisions.

Disadvantageously, damage to the measurement instrument and/or the component can slow down the manufacture and quality control process thereby impacting the rate of production of said components.

Disadvantageously, damage to the measurement instrument and/or the component may thereby incur costs associated with replacing the measurement instrument and/or the component.

WO2007129037A1 describes a metrological apparatus for measuring surface characteristics of a component. JP2009265023A describes a workpiece measuring device and a collision avoidance device. JP6175249B2 describes a collision avoidance system for machine tools. EP2482156B1 describes a machine tool with a device for collision detection. DE60314907T2 describes an Impact Detector for motor vehicles.

### SUMMARY

Aspects of the invention are set out in the independent claims and optional features are set out in the dependent claims. Aspects of the disclosure may be provided in conjunction with each other, and features of one aspect may be applied to other aspects.

An aspect of the disclosure provides a collision protection apparatus for a measurement instrument the measurement instrument comprising: a rotatable mounting for rotating a component to be measured; a measurement probe configured to: perform a surface measurement of the component as the component rotates on the rotatable mounting; and, move relative to the component at a movement speed; the collision protection apparatus comprising: a proximity sensor configured to provide a proximity signal indicative of the proximity of the measurement probe to the component; and a control means configured to monitor the proximity signal and to reduce the movement speed in the event that the proximity signal indicates that the measurement probe is within a threshold distance of the component.

In examples, the measurement probe of known measurement instruments can collide with the component to be measured resulting in damage to the measurement probe and/or the component. Often the components are very precisely engineered (e.g. requiring a great deal of time and money to manufacture) and, therefore, any damage caused to the components can render them unsuitable for their purpose. In such examples, the entire component needs to be replaced.

Advantageously, the collision protection apparatus may prevent collisions or alternatively, reduce or prevent the damage to the component and/or the measurement instrument.

The collision protection apparatus may further comprise: a contact sensor wherein the control means is configured to stop relative movement between the measurement probe and the component in the event that the contact sensor indicates contact with the component.

An aspect of the disclosure provides a collision protection apparatus for a measurement instrument, the measurement instrument comprising: a rotatable mounting for rotating a component to be measured; a measurement probe configured to perform a surface measurement of the component as the component rotates on the rotatable mounting; move relative to the component at a movement speed; the collision protection apparatus comprising a contact sensor for sensing contact with the component; and, a control means configured to stop movement of the measurement probe in the event that the contact sensor indicates contact with the component.

Advantageously, the contact sensor may prevent further damage to the component after a collision has occurred between the measurement instrument (e.g. at the location of the contact sensor disposed in the measurement instrument, for example, on the measurement probe) and the component.

For example, rotation of the rotatable mounting may cease in response to the contact sensor indicating (e.g. by generation of contact indication) that there is contact between the measurement instrument and the component thereby preventing the component being further rotated which might cause further damage (e.g. in the shape of a ring or arc around the component). Put simply, using the measurement instrument with collision protection apparatus with a contact sensor as described herein may reduce the amount of damage to the component in comparison to when a measurement instrument without a collision apparatus with a contact sensor as recited herein.

The control means may be configured to reduce a limit of the movement speed based on the proximity signal so that the limit gets lower as the measurement probe moves closer to the component.

The greater the movement speed, then the greater the impact force of collision (e.g. the impulse/change of momentum imparted on the component by the measurement apparatus) and correspondingly, the greater amount of damage applied to the component. Advantageously, as the likelihood of collision increases (i.e. because the measurement probe is moved closer to the component) the movement speed is decreased, therefore, reducing the amount of damage to the component in the event of a collision.

For example, the control means may determine a limit of the movement speed (e.g. a movement speed limit) L based on a continuous linear relationship between the proximity d indicated by the proximity signal and movement speed limit L e.g. L=m·d+c wherein m and c are natural numbers.

For example, the control means may determine a limit of movement speed limit L based on a discontinuous relationship between the proximity d indicated by the proximity signal and movement speed limit L e.g.: L₁ if d<d₁; L₂ if d<d₂ etc, wherein L₁ and L₂ are movement speed limits, d₁ and d₂ are predetermined proximity thresholds, and wherein L₁<L₂ and d₁<d₂.

The limit of movement speed may be selected based on the proximity of the measurement probe to the component so that the distance between the component and the measurement probe is not less than a stopping distance of the measurement probe.

The stopping distance may refer to the distance through which the measurement probe moves relative to the component (or vice versa) from the time the measurement instrument is commanded to cease the relative movement and the time at which the relative movement actual ceases.

In the event that the measurement instrument is commanded to cease the relative movement (e.g. in response to an indication from the contact sensor) then the relative movement will stop before a collision between the measurement instrument (e.g. the measurement probe) and the component. Advantageously, damage due to a collision may be prevented.

The proximity sensor may be provided in a housing, which encapsulates the proximity sensor and which is securable to the measurement instrument.

For example, in the case that the measurement instrument is a roundness measurement instrument, the housing may permit the proximity sensor to be secured to any of: the measurement probe; the traverse arm; the carriage; and, the pillar.

For example, in the case that the measurement instrument is a optical profiling measurement instrument, the housing may permit the proximity sensor to be secured to any of: the measurement probe; the movable frame; and, the cylindrical mirror.

The housing of the proximity sensor may comprise a fixture for securing the proximity sensor to the measurement probe.

The fixture may comprise an adhesive.

In examples, the fixture on the housing of the proximity sensor may comprise a first feature and the measurement probe may comprise a mounting comprising a second feature wherein the first feature corresponds to the second feature to permit attachment of the first feature to the second feature. For example, the first feature may comprise a male portion (e.g. a male thread) and the second feature may comprise a female portion (e.g. a female thread) or the first feature may comprise a plurality of loops and the second feature may comprise a plurality of hooks.

The proximity sensor may comprise a plurality of sensor units, wherein the sensor units each provide directional sensing for sensing proximity in a particular direction from the sensor.

In examples, the measurement instrument may comprise a roundness measurement instrument wherein the measurement probe is configured to perform a first roundness measurement at a first measurement site on the component and to move along a trajectory at the movement speed to a second measurement site on the component for performing a second roundness measurement.

When moving along a trajectory from a first measurement site to a second measurement site, measurement probe of roundness measurement instruments may collide with the component to be measured, thereby causing damage to the component and/or the measurement probe. Advantageously, the collision protection apparatus may prevent or reduce the damage in the event of collisions (or indeed prevent collisions) in the event that: the measurement probe of the roundness measurement instrument is at a measuring site; and, the measurement probe is moved along the trajectory from a first measurement site to a second measurement site.

The measurement probe may be mounted on a traverse arm for movement of the measurement probe in a traverse direction, and the traverse arm is mounted on a carriage translatable along a pillar in a pillar direction, perpendicular to the traverse direction.

The collision protection apparatus may comprise a mounting for mounting a first one of said proximity sensor units on a first side of the carriage spaced from the measurement probe in the carriage direction and directed for sensing proximity in the carriage direction.

The collision protection apparatus may comprise a second one of said proximity sensor units provided on the mounting on a second side of the carriage, opposite to the first side, and spaced from the measurement probe in the carriage direction and directed for sensing proximity in the carriage direction.

In examples, the measurement instrument may comprise an optical profiling measurement instrument wherein: the rotatable mounting defines an axial direction corresponding the rotational axis of the mounting and a radial direction perpendicular to the axial direction; the measurement probe is coupled to a movable frame wherein the frame is movable in the axial direction and the radial direction relative to the rotatable mounting; the probe is rotatable in a tilt plane defined by the radial direction and the axial direction.

A proximity sensor unit may be mounted on a mounting on a first side of the movable frame directed for sensing proximity in the radial direction.

A proximity sensor unit may be mounted on a mounting on a second side of the movable frame directed for sensing proximity in the axial direction.

A proximity sensor unit may be mounted on a mounting on a third side of the movable frame directed for sensing proximity in a direction oblique or perpendicular to the tilt plane.

The contact sensor may comprise a cushion for absorbing an impact force of collision between the roundness measurement instrument and the component. For example, the cushion may absorb an impact force of collision between the carriage and the component.

The contact sensor may comprise a cushion for absorbing an impact force of collision between the optical profiling measurement instrument and the component. For example, the cushion may absorb an impact force of collision between the movable frame and the component.

The cushion may have a stiffness selected based on a sensitivity of the contact sensor, such that compression of the cushion triggers the contact sensor.

The cushion may comprise a laminar element configured to be secured to a surface of the measurement instrument. The laminar element is flexible to enable the cushion to conform to the measurement instrument.

The contact sensor may comprise a force sensing resistor.

The contact sensor is at least one of (i) disposed at a surface of the cushion (e.g. between the cushion and the measurement instrument), and (ii) integrated with the cushion.

The proximity sensor may comprise an optical sensor, such as a Lidar sensor.

An aspect of the disclosure provides a method of controlling a measurement instrument for avoiding collisions between the measurement instrument and a component to be measured, wherein the measurement instrument comprises a rotatable mounting for rotating a component for measurement, the measurement instrument is configured to control the measurement probe to perform a surface measurement of the component as the component rotates on the rotatable mounting, the method comprising: operating a proximity sensor for sensing proximity between the measurement probe and the component, monitoring the proximity while moving the measurement probe relative to the component at a movement speed; and reducing the movement speed in the event that proximity sensor indicates that the measurement probe is within a threshold distance of the component.

In examples, the measurement probe of known measurement instruments can collide with the component to be measured resulting in damage to the measurement probe and/or the component. Often the components are very precisely engineered (e.g. requiring a great deal of time and money to manufacture) and, therefore, any damage caused to the components can render them unsuitable for their purpose. In such examples, the entire component needs to be replaced.

Advantageously, the method may prevent collisions or alternatively, reduce or prevent the damage to the component and/or the measurement instrument.

The method may comprise: stopping movement of the measurement probe in the event that a contact sensor indicates that the measurement probe is in contact with the component.

An aspect of the disclosure provides a computer program product configured to program a control means of a measurement instrument to perform any of the method described herein, wherein the control means of the measurement instrument comprises a signal interface for connecting the control means to receive said proximity signals and/or said contact sensing signals.

An aspect of the disclosure provides a kit for adapting a measurement instrument to provide collision protection, the kit comprising a proximity sensor configured to provide a proximity signal indicative of the proximity of the measurement probe to the component and a contact sensor for sensing contact with the component; and the kit further comprising the computer program product configured to program a control means of a measurement instrument to perform any of the method described herein, wherein the control means of the measurement instrument comprises a signal interface for connecting the control means to receive said proximity signals and/or said contact sensing signals.

The kit may have a proximity sensor with a housing, which encapsulates the proximity sensor and which is securable to the measurement instrument. For example wherein the housing of the proximity sensor carries a fixing means for securing the proximity sensor to the measurement instrument.

The kit may have a contact sensor comprising with a cushion, provided as a flexible laminar element which is conformable to a surface of the measurement instrument, for example wherein the cushion is configured to adhere to the measurement instrument.

An aspect of the disclosure provides a method of adapting a measurement instrument to provide collision protection for collisions between a measurement probe and a component, wherein the measurement instrument comprises: a rotatable mounting for rotating a component for measurement; a measurement probe configured to: perform a surface measurement of the component as the component rotates on the rotatable mounting; move relative to the component at a movement speed; the method comprising at least one of: providing a proximity sensor wherein the proximity sensor is: configured to provide a proximity signal indicative of the proximity of the measurement probe to the component; and, operable to reduce the movement speed in the event that the proximity signal indicates that the measurement probe is within a threshold distance of the component; disposing, on a measurement probe, a contact sensor wherein the contact sensor is: configured to sense contact between the contact sensor and the measurement instrument; and, operable to stop movement of the measurement probe in the event that the contact sensor indicates contact with the component.

An aspect of the disclosure provides a measurement instrument for performing measurements of a component, the measurement instrument comprising: a rotatable mounting for rotating a component for measurement; a measurement probe configured to: perform a surface measurement of the component as the component rotates on the rotatable mounting; move relative to the component at a movement speed; a collision protection apparatus comprising: a proximity sensor configured to provide a proximity signal indicative of the proximity of the measurement probe to the component; a control means configured to monitor the proximity signal and to reduce the movement speed in the event that the proximity signal indicates that the measurement probe is within a threshold distance of the component; and, a contact sensor wherein the control means is configured to stop relative movement between the measurement probe and the component in the event that the contact sensor indicates contact with the component.

For example, the control means may determine a movement speed V based on a continuous linear relationship between the proximity d indicated by the proximity signal and movement speed V e.g. V=m·d+c wherein m and c are natural numbers.

For example, the control means may determine a movement speed V based on a discontinuous relationship between the proximity d indicated by the proximity signal and movement speed V e.g.: V₁ if d<d₁; V₂ if d<d₂ etc, wherein V₁ and V₂ are movement speeds, d₁ and d₂ are predetermined proximity thresholds, and wherein V₁<V₂ and d₁<d₂.

An aspect of the disclosure provides a method of controlling a measurement instrument (100; 200) for avoiding collisions between the measurement instrument and a component (190; 290) to be measured, wherein the measurement instrument comprises a rotatable mounting (120; 220) for rotating a component (190; 290) for measurement, the measurement instrument (100) is configured to control the measurement probe (160; 260) to perform a surface measurement of the component (190; 290) as the component rotates on the rotatable mounting (120; 220) and the measurement probe moves relative to the component at a movement speed, the method comprising: obtaining a first distance signal from a first distance sensor wherein the first distance signal is indicative of the distance between the component and the first distance sensor; defining a first threshold region around the component based on the first distance signal; reducing the movement speed to a first movement speed in the event that the measurement probe is within the first threshold region.

In examples, a limit on the maximum movement speed may be enforced in the event that the measurement probe is within the first threshold region.

In examples, the first threshold region may be delimited by a first threshold surface, for example, a cylinder with radius of a first distance centred on the rotational axis of the rotatable mounting. The first distance may be based on the first distance signal e.g. the first distance may be the distance indicated by the first distance signal plus a first offset distance.

In examples, the method may comprise defining a second threshold region around the component based on the first distance signal, wherein the second threshold region is different from the first threshold region and reducing the movement speed to a second movement speed in the event that the measurement probe is within the second threshold region.

The second threshold region may be delimited by a second threshold surface, for example, a cylinder with radius of a second distance centred on the rotational axis of the rotatable mounting. The second distance may be based on the first distance signal e.g. the second distance may be the distance indicated by the first distance signal plus a second offset distance (which is less than the first offset distance). In such examples, the second threshold distance may be less than the first threshold distance. In examples wherein the second threshold distance is less than the first threshold distance, the second movement speed is less than the first movement speed.

In examples: the first distance signal is obtained from the first distance sensor in a first location wherein the first distance signal is indicative of the distance between the component and the first distance sensor in the first location; and, the method further comprising: obtaining a second distance signal from the first distance sensor in a second location wherein the second distance signal is indicative of the distance between the component and the first distance sensor in the second location; defining the first threshold region around the component based on the first distance signal and the second distance signal.

In such examples, the first threshold region may be a delimited by a first threshold surface, for example, a cylinder with a radius of a first average distance centred on the rotational axis of the rotatable mounting. In such examples, the first average distance may be determined by averaging a threshold distance obtained from the first distance signal and a threshold distance obtained from the second distance signal.

In examples the method may comprise: moving the first distance sensor from the first location to the second location.

In examples the method may comprise: the first distance signal is obtained from the first distance sensor in a first location wherein the first distance signal is indicative of the distance between the component and the first distance sensor in the first location; and, the method further comprising: obtaining a second distance signal from a second distance sensor in a second location, wherein the second distance signal is indicative of the distance between the component and the second distance sensor in the second location; defining the first threshold region around the component based on the first distance signal and the second distance signal.

In examples, the first threshold region may be delimited by a first threshold surface wherein the first threshold surface is disposed a constant distance from the surface of the component. For example, the first threshold region may be surface containing all points disposed at a first threshold distance from the surface of the component. In more detail, taking a straight line with a length of the first threshold length disposed perpendicular to a point of the surface of the component, then the end of the straight line distal from the surface of the component is a point in the first threshold surface. The first threshold surface contains all such points for each point on the surface of the component.

In examples, the method may comprise defining a second threshold region around the component based on the first distance signal, wherein the second threshold region is different from the first threshold region. The second threshold region may be defined in the same manner as the first threshold region i.e. in terms of a second threshold surface and a second threshold distance. In such examples, the second threshold distance may be less than the first threshold distance.

The method may comprise: determining if the measurement probe is within the first threshold region based on a position signal wherein the position signal is indicative of the position of the measurement probe relative to the component.

The method may further comprise: the position signal is provided by a control means of the measurement instrument.

The method may comprises: stopping movement of the measurement probe in the event that a contact sensor indicates contact between the component and the measurement instrument.

An aspect of a collision protection apparatus for a measurement instrument, the measurement instrument comprising: a rotatable mounting for rotating a component to be measured; a measurement probe configured to: perform a surface measurement of the component as the component rotates on the rotatable mounting; and, move relative to the component at a movement speed; the collision protection apparatus comprising: a first distance sensor, wherein the first distance sensor is configured to provide a first distance signal indicative of the distance between the component and the first distance sensor; a control means configured to: define a first threshold region around the component based on the first distance signal; reduce the movement speed in the event that the measurement probe enters the first threshold region.

In examples, the first threshold region may be delimited by a first threshold surface, for example, a cylinder with radius of a first distance centred on the rotational axis of the rotatable mounting. The first distance may be based on the first distance signal e.g. the first distance may be the distance indicated by the first distance signal plus a first offset distance.

In examples, the method may comprise defining a second threshold region around the component based on the first distance signal, wherein the second threshold region is different from the first threshold region and reducing the movement speed to a second movement speed in the event that the measurement probe is within the second threshold region.

The second threshold region may be delimited by a second threshold surface, for example, a cylinder with radius of a second distance centred on the rotational axis of the rotatable mounting. The second distance may be based on the first distance signal e.g. the second distance may be the distance indicated by the first distance signal plus a second offset distance (wherein the second offset distance is less than the first offset distance). In such examples, the second threshold distance may be less than the first threshold distance. In examples wherein the second threshold distance is less than the first threshold distance, the second movement speed is less than the first movement speed.

The first distance signal may be obtained from the first distance sensor disposed in a first location wherein the first distance signal is indicative of the distance between the component and the first distance sensor disposed in the first location; and, wherein: the first distance sensor is configured to: provide a second distance signal from the first distance sensor disposed in a second location, wherein the second distance signal is indicative of the distance between the component and the first distance sensor disposed in the second location; the control means is configured to: define the first threshold region around the component based on the first distance signal and the second distance signal.

The first distance sensor may be movable from the first location to the second location. For example, the first distance sensor may be moved by moving any of the pillar, carriage, or traverse arm of the collision protection apparatus.

The first distance signal may be obtained from the first distance sensor distance in a first location wherein the first distance signal is indicative of the distance between the component and the first distance sensor disposed in the first location; and, the collision protection apparatus further comprising: a second distance sensor, wherein the second distance sensor is configured to provide a second distance signal indicative of the distance between the component and the second distance sensor disposed in a second location; and, the control means is configured to: define the first threshold region around the component based on the first distance signal and the second distance signal.

In examples, the distance indicated by the first distance signal and second distance signal may be averaged to obtain an averaged distance. The first threshold distance may be defined as the average distance plus first offset distance and the first threshold region may be a cylinder centred on the rotational axis X and having a radius of the first threshold distance. In a similar manner, a second threshold distance be defined e.g. the average distance plus a second offset distance.

The control means may be configured to define if the measurement probe is within the first threshold region based on a position signal wherein the position signal is indicative of the position of the measurement probe relative to the component.

The position signal may be provided by a control means of the measurement instrument.

The control means may be configured to: stop movement of the measurement probe in the event that a contact sensor indicates contact between the component and the measurement instrument.

### DRAWINGS

FIG. 1A illustrates a perspective view of a roundness measurement instrument with a component to be measured;

FIG. 1B illustrates a perspective view of a carriage assembly, a transverse arm, and a measurement probe of the roundness measurement instrument illustrated in FIG. 1A;

FIG. 2 illustrates a plan view of an optical profiling measurement instrument with a component to be measured;

FIG. 3A illustrates a plan view, parallel to a traverse axis, of a pillar, a carriage, and a traverse arm with a first example of a collision protection apparatus;

FIG. 3B illustrates an enlarged plan view, parallel to the traverse axis of a first contact sensor of the collision protection apparatus and a carriage;

FIG. 4 illustrates a flowchart depicting a method of controlling a roundness measurement instrument for avoiding collisions between the measurement instrument and a component to be measured;

FIG. 5 illustrates a flowchart depicting a method of controlling the roundness measurement instrument for reducing or preventing damage due to collisions between the measurement instrument and a component to be measured;

FIG. 6 illustrates a flowchart depicting a method of stopping movement of a measurement probe in the event that a contact sensor indicates that the measurement probe is in contact with a component;

FIG. 7 illustrates a flowchart depicting a method of controlling a measurement instrument for reducing or preventing damage due to collisions between the measurement instrument and a component to be measured.

Herein like reference signs indicate like elements.

### DESCRIPTION

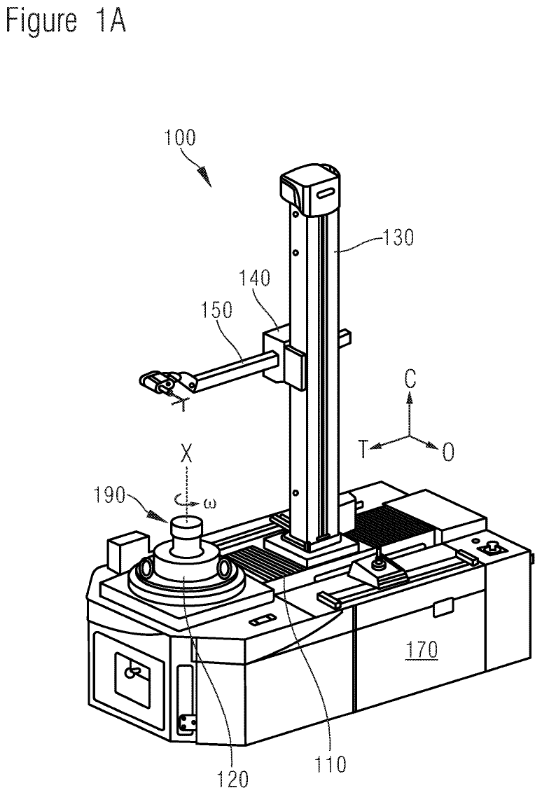

FIG. 1A illustrates a perspective view of a roundness measurement instrument 100 with a component 190 to be measured. FIG. 1B illustrates a perspective view of a carriage 140, a transverse arm 150, a gauge body 160, and a measurement probe 170 of the roundness measurement instrument 100 illustrated in FIG. 1A. The roundness measurement instrument 100 comprises: a base 110; a rotatable mounting 120; a pillar 130; the carriage 140; the traverse arm 150; the gauge body 155; the measurement probe 160; and a control means 170.

The rotatable mounting 120 is connected to the base 110. The pillar 130 is connected to the base 110. The carriage 140 is connected to the pillar 130. The traverse arm 150 is connected to the carriage 140. The gauge body 155 is connected to the traverse arm 150. The measurement probe 160 is connected to the gauge body 155. The control means 170 is connected to the rotatable mounting 120, the pillar 130, carriage 140, the traverse arm 150, and the gauge body to thereby control movement of these elements.

Shown next adjacent the roundness measurement instrument 100 is a set of orthogonal axes: a carriage axis C pointing in a direction parallel to the pillar 130; a traverse axis T pointing in direction parallel to the traverse arm 150; and an orthogonal axis O pointing in a direction perpendicular to the carriage axis C and the traverse axis T.

The carriage axis C defines a carriage direction C (any line parallel to the carriage axis C is a line in the carriage direction) named thus as this is the direction along which the carriage 140 moves relative to the pillar 130. The traverse axis T defines a traverse direction T (any line parallel to the traverse axis T is a line in the traverse direction) named thus as this is the direction along which the traverse arm 150 moves relative to the carriage 140. Likewise, the orthogonal axis O defines an orthogonal direction O (any line parallel to the orthogonal axis O is a line in the orthogonal direction) named thus as this is the direction orthogonal to the traverse axis T and the carriage axis C.

Also shown is a probe direction P which corresponds to the direction in which the probe is pointing. In FIG. 1B, the probe direction P is pointing in the orthogonal direction O. However, as described below, the probe (and thus the probe direction P) is rotatable in the plane defined by the carriage axis C and the orthogonal axis O, the C—O plane. The probe direction is rotatable in the C—O plane so that the probe direction can be disposed in the orthogonal direction, in the carriage direction C and directions oblique to both the carriage axis C and the orthogonal axis. The probe direction is always perpendicular to the traverse axis T.

The pillar 130 is movable relative to the base 110 in the traverse direction T. The carriage 140 is movable relative to the pillar 130 in the carriage direction C. The traverse arm 150 is movable relative to the carriage 140 in the traverse direction T. The gauge body 155 is rotatable relative to the traverse arm 150 to thereby change the probe direction P. The gauge body 155 is rotatable in the C—O plane. The gauge body 155 is rotatable about a gauge body axis which is oblique to at least one of the traverse axis T and the carriage axis C. In the example shown in FIG. 1A, the gauge body axis is disposed at 45° to the carriage axis C and perpendicular to the traverse axis. By affecting a 180° turn around the rotational axis, the measurement probe attached to the gauge body can be moved from pointing in an initial probe direction along the orthogonal axis O (i.e. perpendicular to the carriage direction C and the traverse direction T) to a final probe direction parallel to the carriage direction C (i.e. perpendicular to the traverse direction T and the orthogonal direction O). The measurement probe 160 is movable in two linear directions (the carriage direction C and the traverse direction T) with appropriate displacements of the measurement 160 probe in the carriage direction C (i.e. by moving the carriage 140 along pillar 130), and the traverse direction T (i.e. by moving the traverse arm 150 relative to the carriage 140). The measurement probe is rotationally movable (i.e. the probe direction can be changed) in the C—O plane defined by the carriage axis C and the orthogonal axis O by rotations about the gauge body axis.

In examples, the measurement probe comprises a straight stylus is provided such as that shown in FIGS. 1A and 1B. In examples, straight stylus can be replaced with a right angle stylus, wherein the stylus is L-shaped i.e. the measurement probe comprises a stylus with a 90° corner.

Components to be measured (e.g. sometimes referred to as workpieces), such as component 190 can be mounted on the rotatable mounting 120. Components mounted on the rotatable mounting 120 are rotated by the rotatable mounting 120 around rotational axis X. The rotational axis X is parallel to the carriage axis C.

For the roundness measurement instrument 100 to perform a roundness measurement of the component 190, first the roundness measurement instrument 100 is calibrated. The calibration consists of a computer (not shown in FIGS. 1A and 1B) storing the initial positions of the pillar 130, carriage 140, the traverse arm 150 and, the gauge body 155. Subsequent displacements of the pillar are determined relative to the initial position of the pillar 130. Likewise, subsequent displacements of the carriage 140 and the traverse arm 150 are determined relative to the initial position of the carriage 140 and the initial position of the traverse arm 150 respectively. Subsequent rotations of the gauge body 155 are determined relative to the initial rotational position of the gauge body 155.

Next the component 190 is mounted on the rotatable mounting 120. Then the measurement probe 160 is moved to a first measurement site. At the first measurement site the measurement probe 160 is disposed close to but not in contact with the component 190. The measurement probe 160 is manoeuvred to the first measurement site by a combination of any of: movement of the pillar 130 in the traverse direction T; movement of the carriage 140 in the carriage direction C; movement of the traverse arm in the traverse direction T; and, rotation of the measurement probe 160 in the C—O plane. The position of the measurement probe 160 at the first measurement site can be determined by measuring the linear displacements of the pillar 130, carriage 140, and the traverse arm 150 from their respective initial positions and also the rotational displacements of the gauge body 155 in the C—O plane relative to its initial position.

Once the measurement probe 160 is at the first measurement site, then simultaneously: the rotatable mounting 120 rotates the component 190 at an angular speed w around the rotational axis X; and the measurement probe measures the distance between the measurement probe 160 and a surface of the component 190 within the field of view of said probe. The measurement probe 160 is an inductive gauge. The measurement probe 160 is configured to determine the geometry of the surface of the component. The measurement probe 160 has a measurement rate which permits a plurality of measurements to be made in one full revolution of the component 190. The greater the measurement rate, the greater the number of the measurements (and the resulting roundness measurement has greater granularity.

The measured distance is recorded by the computer and associated with the angular displacement of the component 190 when that measurement was made and an indication of the measurement site at which the measurement was made. At the first measurement site, the measurement probe measures a distance d₁ when the angular displacement is 1°, the measurement probe measures a distance d₂ when the angular displacement is 2° and so on. The measurements recorded by the computer d₁, d₂ and so on are associated respectively with the angular displacements 1°, 2° and so on. In this manner, a roundness measurement of the surface of the component 190 is obtained at the first measurement site.

Next the measurement probe 160 is moved from the first measurement site to a second measurement site. The measurement probe 160 moves along a trajectory from the first measurement site to the second measurement site. Moving the measurement probe from the first measurement site to the second measurement site can be done by any of: moving the carriage 140 in the carriage direction C; moving the pillar 130 in the traverse direction T; moving the traverse arm 150 in the traverse direction T; rotating the gauge body 155 about the gauge body axis.

Once the measurement probe 160 is disposed at the second measurement site another roundness measurement is obtained in the same manner as described above with reference to the first measurement site.

In examples, the measurement probe may be moved across the diameter of the component to thereby obtain a cross-sectional profile of the component i.e. in some examples, the component may not be rotated.

The relative movement between the measurement probe 160 and the surface of the component 190 (i.e. during rotation of the component and/or movement of the measurement probe and/or movement along the trajectory between measurement sites) is referred to as movement speed.

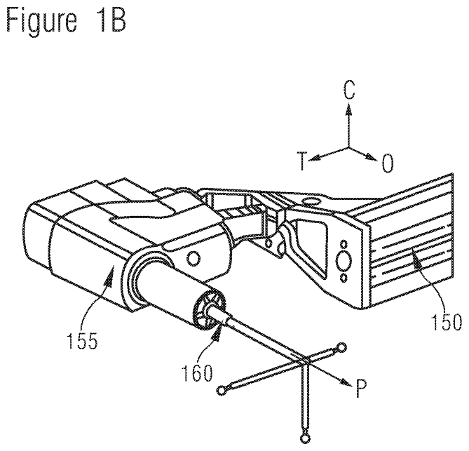

FIG. 2 illustrates a plan view of an optical profiling measurement instrument 200 (also referred to as an optical profilometer) with a component 290 to be measured.

The optical profiling measurement instrument 200 comprises: a base 210; a reference frame 215; a rotatable mounting 220; a movable frame 230; a cylindrical mirror 235, a tilt reference probe 237; a Z-axis reference probe 240; a Z-axis reference mirror 245; an R-axis reference probe 250; an R-axis reference mirror 255; a measurement probe 260. The control means 270 is connected to the rotatable mounting 220, the moveable frame 230, and the measurement probe 260 to thereby control movement of these elements.

The rotatable mounting 220 is connected to the base 210. The reference frame 215 is connected to the base 210. The movable frame 230 is connected to the reference frame 215. The cylindrical mirror 235 is connected to the movable frame 235. The Z-axis reference mirror 245 is attached to a top side of the reference frame 215 opposite the Z-axis reference probe 240. The R-axis reference mirror 255 is attached to a side of the reference frame 215 opposite the R-axis reference probe 250. The measurement probe 260 is attached to the movable frame 230. The tilt reference probe 237 is connected to the measurement probe 260.

Shown next to the optical profiling measurement instrument 200 is a set of orthogonal axes: a Z-axis pointing in a direction parallel to the base 210 (i.e. an axial direction); and, an R-axis pointing in a direction perpendicular to the base 210 (i.e. an R, or radial, direction). The Z-axis and the R-axis define a tilt plane.

The movable frame 230 is movable relative to the base 210 in the axial direction (i.e. along the Z-axis). The movable frame 230 is movable relative to the base 210 in the R direction. The measurement probe 260 is rotatable in the tilt plane relative to the movable frame 230. The tilt reference probe 237 is attached to the measurement probe 260 and therefore moves in unison with the measurement probe (i.e. they move as one unit). The measurement probe 260 is movable in two dimensions with appropriate linear displacements (i.e. in the axial (Z) direction and the R direction) of the movable frame 230 relative to the reference frame 215 and angular displacements (i.e. in the tilt plane) of the measurement probe 260 relative to the movable frame 230.

Components to be measured, such as component 290 can be mounted on the rotatable mounting 220. Components mounted on the rotatable mounting 220 are rotated by the rotatable mounting 220 around rotational axis X. The rotational axis X is parallel to the Z-axis. The rotational axis X is perpendicular to the R-axis.

For the optical profiling measurement instrument 200 to perform an optical profiling measurement of the component 290, first the optical profiling measurement instrument 200 is calibrated. For example, the calibration may be performed as is described in

The axial (Z) displacement of the movable frame 230 is determined using the Z-axis reference probe 240 and the Z-axis reference mirror 245. The Z-axis reference probe 240 and Z-axis reference mirror 245 act as an interferometer i.e.: the Z-axis reference probe 240 is a coherent light source which emits coherent light in the direction of the Z-axis reference mirror 245; the mirror 245 reflects the incident light back toward the Z-axis reference probe 240; the emitted light and reflected light interfere to provide an interference pattern at the Z-axis reference probe 240; the Z-axis reference probe 240 determines the Z displacement of the movable frame 230 based on the interference pattern. The R displacement of the movable frame 230 is determined using the R-axis reference probe 250 and the R-axis reference mirror 255 in the same manner described above with reference to the Z-axis reference probe 240 and the Z-axis reference mirror 245.

The angular displacement of the measurement probe 260 is determined using the tilt reference probe 237 and the cylindrical mirror 235. The tilt reference probe 237 points in the opposition direction to the measurement probe 260 i.e. they both emit light along a line but in opposite directions to one another. The tilt reference probe is disposed opposite the cylindrical mirror 235. The cylindrical mirror 235 is a mirror having the shape of an arc of a circle (i.e. a portion of the circumference of a circle). The ends of the cylindrical mirror subtend an angle of at least 90°. The measurement probe 260 and the tilt reference probe 237 are disposed at the centre point of the arc (i.e. wherein the arc is a defines a locus from said centre point) and rotate about this centre point. The tilt reference probe 237 is disposed facing the cylindrical mirror 235 so that coherent light emitted from the tilt reference probe 237 is incident on the cylindrical mirror 235. In examples, the angular displacement of the measurement probe 260 may be determined using an rotary encoder and the angular displacement data sent to the controller 270.

The measurement instrument 200 may be operated in the manner described in any of US2013308139A1 and DE102008033942B3.

Next the component 290 is mounted on the rotatable mounting 220. Then the measurement probe 260 is moved to an initial measurement site. In the present example, the initial measurement site is on an outer radial edge 292 of the surface of the component (i.e. the furthest point on the surface of the component from the rotational axis X). At the initial measurement site the measurement probe 260 is disposed perpendicular to the surface of the component 290. The measurement probe 260 is manoeuvred to be perpendicular to the first measurement site by a combination of any of: movement of the movable frame 230 in the axial direction; movement of the movable frame 230 in the R direction; and, (rotational) movement of the measurement probe 260 in the tilt plane. The position of the measurement probe 260 at the initial measurement site can be determined by measuring the displacements of the movable frame 230 and the measurement probe 260 (i.e. via rotational displacement of the tilt probe 237 relative to the cylindrical mirror 235) from their respective initial positions.

Once the measurement probe 260 is at the initial measurement site, then simultaneously: the rotatable mounting 220 rotates the component 290 at an angular speed w around the rotational axis X; and the measurement probe 260 is maintained perpendicular to the surface of the component whilst measuring the distance between the measurement probe 260 and the surface of the component 290. The measurement probe 260 uses interferometry (e.g. phase grating interferometry, PGI) to measure distance between the measurement probe 260 and component 290 at the focal point. The measurement probe 260 is kept perpendicular to the surface by adjusting the angular displacement of the measurement probe 260. The measurement probe 260 has a measurement rate which permits a plurality of measurements can be made in one full revolution of the component 290. The greater the measurement rate, the greater the number of the measurements obtained (and the resulting optical profile has a greater granularity).

For example, the measured geometry of the surface of the component 290 is compared to the expected geometry of the surface of the component (e.g. a completely round component) and the differences between the measured geometry and the expected geometry can be used to provide an indication of the degree to which the measured geometry conforms with the expected geometry.

The relative movement between the measurement probe 260 and the surface of the component 290 (i.e. during rotation of the component and/or movement of the measurement probe) is referred to as movement speed.

After a full revolution of the component 290 is made, the measurement probe 260 is moved in the radial direction (direction of the R-axis) towards the rotational axis X by a radial increment. The component is then rotated through another complete revolution whilst measurements are made as described above. The radial increments are applied until the measurement probe measures the point on the surface of the component 290 which the rotational axis X intersects. The radial increments and revolutions of the component 290 may be performed simultaneously e.g. smoothly so that the measurement probe 290 moves in a spiral around and toward the rotational axis X.

Measurement probe 260 and the tilt reference probe may be short coherence interferometers (i.e. superluminescent diodes (SLEDs) with filters replacing lasers).

In examples, the measurement probe may be moved across the diameter of the component to thereby obtain a cross-sectional profile of the component i.e. in some examples, the component may not be rotated.

The present disclosure provides a collision protection apparatus for a measurement instrument for prevent or reducing damage to a component and/or measurement instrument in the event of a collision between the two.

The collision protection apparatus is configured for use with two different types of measurement instrument: roundness measurement instrument and optical profiling measurement instruments (i.e. optical profilometers).

A collision between the roundness measurement instrument and the component includes any of: contact between the pillar and the component; contact between the carriage and the component; contact between the traverse arm and the component; contact between the gauge body and the component; contact between the measurement probe and the component; and, contact between the gauge body and component.

A collision between the optical profiling measurement instrument and the component includes any of: contact between the movable frame and the component; contact between the cylindrical mirror and the component; and, contact between the measurement probe and the component.

Roundness measurement instruments and optical profiling measurement instruments are described in the background section above.

Both types of measurement instruments comprise: a rotatable mounting (120; 220) for rotating a component (190; 290) to be measured; a measurement probe (160; 260) configured to: perform a surface measurement of the component (190; 290) as the component rotates on the rotatable mounting (120; 220); and, move relative to the component at a movement speed.

The collision protection apparatus described herein may be embodied by a number of different examples.

A first example of the collision protection apparatus described herein comprises a control means, a proximity sensor (e.g. a lidar sensor) and a contact sensor (e.g. a force sensing resistor (FSR)), wherein: the proximity sensor is configured to provide a proximity signal indicative of the proximity of the measurement probe to the component; and the control means configured to monitor the proximity signal and to reduce the movement speed in the event that the proximity signal indicates that the measurement probe is within a threshold distance of the component; and, the contact sensor is configured to sense contact with the component; and, the control means configured to stop movement of the measurement probe in the event that the contact sensor indicates contact with the component.

A second example of the collision protection apparatus described herein comprises a control means and a proximity sensor (e.g. a lidar sensor), wherein the proximity sensor is configured to provide a proximity signal indicative of the proximity of the measurement probe to the component; and the control means configured to monitor the proximity signal and to reduce the movement speed in the event that the proximity signal indicates that the measurement probe is within a threshold distance of the component.

A third example of the collision protection apparatus described herein comprises a control means and a contact sensor (e.g. an FSR) wherein the contact sensor is configured to sense contact with the component; and, the control means configured to stop movement of the measurement probe in the event that the contact sensor indicates contact with the component.

A fourth example of the collision protection apparatus comprises a control means a proximity sensor (e.g. a lidar sensor) wherein the a proximity sensor configured to provide a proximity signal indicative of the proximity of the measurement probe to the component before relative movement of the of the measurement probe to the component is initiated; and the control means is configured to: determine the movement speed as a function of position of the measurement probe relative to the component; move the measurement probe at the movement speed as a function of position.

It will be appreciated that this list of examples is not exhaustive.

### First Example of the Collision Protection Apparatus

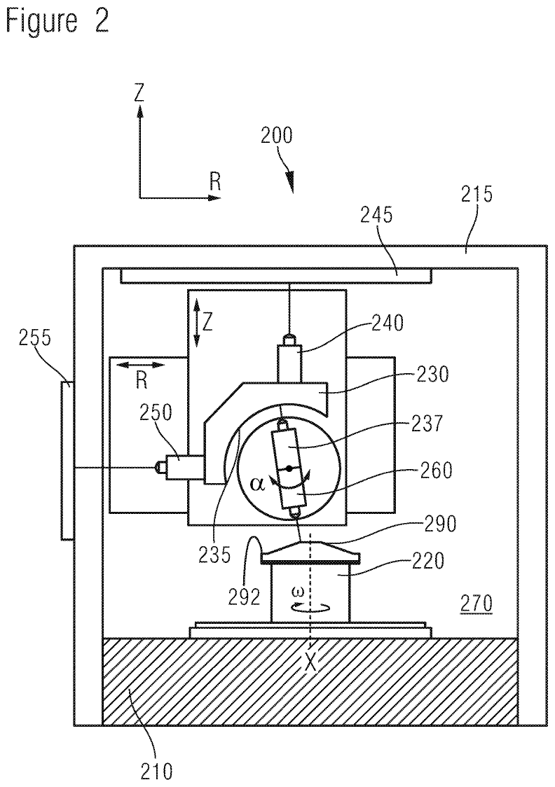

The roundness measurement instrument 100 (described above with reference to FIGS. 1A and 1B) is provided with a first example of the collision protection apparatus 300. FIG. 3A illustrates a plan view, parallel to the traverse axis, of the traverse arm 150, the bracket 151 the gauge body 155, the measurement probe 160 with the first example of the collision protection apparatus 300.

The collision protection apparatus 300 comprises: a control means 170; a plurality of proximity sensors 310A to 310D; and, a plurality of contact sensors 320A to 320H.

FIG. 3A shows the set of orthogonal axes, namely, the carriage axis C in the plane of the page, the traverse axis T in the plane of the page, and the orthogonal axis O which points in a direction out of, and perpendicular to, the page. FIG. 3B (described in more detail below) also shows the set of orthogonal axes.

In the present example, the control means 170 of the collision protection apparatus 300 is the same control means 170 for controlling the roundness measurement instrument 100.

The control means 170 is configured to receive proximity signals from the proximity sensors 310A to 310D e.g. the control means 170 is connected (e.g. communicatively with wires or wirelessly) to the proximity sensors 310A to 310D. The control means 170 is configured to receive contact signals from the contact sensors 320A to 320H e.g. the control means 170 is connected (e.g. communicatively with wires or wirelessly) to the contact sensors 320A to 320H.

In other examples, the control means of the collision protection apparatus may be separate from the control means for controlling the roundness measurement instrument (described in more detail below).

First and fourth proximity sensors 310A & 310D are connected to the traverse arm 150. Second and third proximity sensors 310B & 310C are connected to the bracket 151. The first proximity sensor 310A and the second proximity sensor 310B are disposed on an upper side of the traverse arm 150. The third proximity sensor 310C and the fourth proximity sensor 320D are disposed on a lower side of the traverse arm 150.

In examples, each of the proximity sensors may be provided with a housing. Each housing encapsulates (e.g. surrounds at least part of) one of the proximity sensors. In examples, at least part of the housing is transparent to the radiation used by the proximity sensor (e.g. transparent to the frequency (or frequencies) of light used by the lidar proximity sensor) e.g. the housing comprises a coverglass window to permit light to pass therethrough.

Each housing comprises a fixture configured to permit the housing to be secured to the measurement instrument (e.g. on the measurement probe and/or the traverse arm and/or the carriage and/or the pillar). For example, the fixture may comprise at least one of: an adhesive compound; double sided adhesive substrate; screws and bolts; hooks and/or loops (with corresponding hooks and/or loops provided on the measurement instrument); a strap; et cetera.

The plurality of contact sensors 320A to 320H are connected to the gauge body 155. A first contact sensor 320A, a second contact sensor 320B, a third contact sensor 320C, and, a fourth contact sensor 320D are disposed on an upper face 157 of the gauge body 155. The first contact sensor 320A is disposed furthest from the pillar 130, the second contact sensor 320B is disposed next furthest from the pillar 130, the fourth contact sensor 320D is disposed the closest to the pillar 130 and the third contact sensor 320C is disposed next closest to the pillar 130. A fifth contact sensor 320E, a sixth contact sensor 320F, a seventh contact sensor 320G, and, an eighth contact sensor 320H are disposed on a lower face 159 of the gauge body 155. The fifth contact sensor 320E is disposed furthest from the pillar 130, the sixth contact sensor 320F is disposed next furthest from the pillar 130, the eighth contact sensor 320H is disposed the closest to the pillar 130 and the seventh contact sensor 320G is disposed next closest to the pillar 130.

The plurality of proximity sensors 310A to 310D are connected to control means 170 i.e. so that proximity indications generated by the proximity sensors 310A to 310D are sent to the control means 170. The plurality of contact sensors 320A to 320H are connected to control means 170 i.e. so that contact indications generated by the contact sensors 320A to 320H are sent to the control means 170.

Each of the proximity sensors 310A to 310D have a field of view (FOV) which is a right circular cone wherein the vertex of said cone is located at the proximity sensor 310A to 310D. Each cone has a longitudinal axis which passes through the vertex of the cone extending perpendicularly to the base of the cone. The longitudinal axis of each cone is indicative of the direction of the FOV of each respective proximity sensor. In the present example, the direction of the FOV of all of the proximity sensors 310A to 310D is parallel to the traverse axis T.

In examples, each of the proximity sensors may be a lidar detector having an emitter and a detector spaced slightly apart (e.g. ˜3 mm) wherein each emitter and detector has its own FOV. In such examples, there may be a small (e.g. ˜10 mm) exclusion zone and an effective FOV for the sensor where the emitter and detector FOV cones overlap. The first proximity sensor 310A generates a proximity indication in the event that an item (e.g. the component 190) is disposed within the FOV of the first proximity sensor 310A. The other proximity sensors 310B to 310D operate in the same manner. In the present example, a proximity indication generated by the first proximity sensor 310A comprises an indication of the distance between the first proximity sensor 310A and the item in the FOV of the proximity sensor. The generated proximity indication is sent to the control means 170. The proximity sensor may generate proximity indications on a continuous basis e.g. the first proximity sensor 310A sends a proximity indication to the control means 170 at a selected sampling rate. The sampling rate may be one proximity indication sent to the control means every 10 milliseconds e.g. 100 proximity indications per second. In examples, the control means may store the distance between the measurement probe 160 and the first proximity sensor 310A.

In examples, each proximity sensor may comprise a plurality of sensor units. The sensor units each provide directional sensing for sensing proximity in a particular direction from the sensor. In such examples, a first proximity sensor may comprise a first sensor unit, a second sensor unit and a third sensor unit. In such examples, the first sensor unit has a direction of FOV aligned with the carriage axis C, the second sensor unit has a direction of FOV aligned with the traverse axis T, and the third sensor unit has a direction of FOV aligned with the orthogonal axis O. Furthermore, a second proximity sensor may comprise a fourth sensor unit and a fifth sensor unit. The direction of FOV of the fourth sensor and fifth sensor may be parallel but in different directions e.g. the fourth sensor having a direction of FOV in a positive carriage direction (+C) and the fifth sensor have a direction of FOV in a negative carriage direction (−C). For example, each of the sensor units may be Lidar sensor.

In examples, one or more additional proximity sensors may be included. Each of the one or more additional proximity sensors provides directional sensing for sensing proximity in a particular direction from the sensor. Each of the one or more additional proximity sensors provides directional sensing in the T-O plane (e.g. disposed at a ±45° angle to the T axis and at a ±45° angle to the O axis. In such examples, the one or more additional proximity sensors may provide more consistent but less accurate measurements alongside the transverse pointing sensors due to the shape of the component e.g. where the component is an aero-engine, thin blades are difficult for the proximity sensors to detect in the T direction (i.e. ‘straight on’) but will have a larger surface area to detect by an additional proximity sensor arranged for sensing in the T-O plane.

The control means 170 receives proximity indications from the first proximity sensor 310A. The control means 170 monitors each received proximity indication in series e.g. a first received proximity indication is reviewed first, next a second received proximity indication and so on. The control means 170 determines if the proximity signal indicates that the measurement probe is within a threshold distance of the component.

If the control means 170 determines that the proximity signal indicates that the measurement probe 160 is within a threshold distance of the component 190, then the control means reduces the movement speed to a new movement speed. The new movement speed is selected to reduce any damage to the measurement probe 160 and/or component 190 in the event that the measurement probe 160 and component 190 collide.

If the control means 170 determines that the proximity signal indicates that the measurement probe 160 is not within a threshold distance of the component 190, then no further action is taken be the control means 170 (e.g. the movement speed is not reduced or increased).

After the control means 170 has determined whether a proximity signal indicates that the measurement probe 160 is within a threshold distance and taken any subsequent action (e.g. reducing the movement speed) then the control means 170 determines whether a subsequent proximity signal indicates that the measurement probe 160 is within a threshold distance and so on.

In examples, the control means 170 can increase the movement speed if the proximity signal indicates that the measurement probe 160 is outside of a threshold distance (e.g. increase the movement speed to a maximum movement speed).

In examples, the control means reduces the movement speed in proportion to the proximity of the measurement probe to the component (e.g. there is a linear relationship between movement speed and the distance between the measurement probe and the component). For example, as measurement probe is moved closer to the component (i.e. the distance between the two is reduced) the control means reduces the movement speed.

FIG. 3B illustrates an enlarged plan view, parallel to the traverse axis of the first contact sensor 320A and the gauge body 155.

The first contact sensor 320A comprises: a cushion 322A; and, a contact indication generator 324A. The contact indication generator 324 is disposed on the gauge body 155. The cushion 322A is disposed on the contact indication generator 324. The contact indication generator 324A separates the gauge body 155 from the cushion 322A. The other contact sensors 320B to 320H have a similar construction i.e. they all have a cushion and a contact indication generator, wherein the contact indication generator separates the gauge body 155 and the cushion.

When the first contact sensor 320A impacts (e.g. moved into contact with) an item (i.e. through movement of any of: the rotatable mounting 120; the pillar 130; the carriage 140; the traverse arm 150; and, the gauge body 155) the cushion 322A is pushed into the contact indication generator 324A thereby triggering the contacting indication generator 324A to generate a contact indication. The cushion 322A deforms upon contact with the item thereby damping the impact force of collision applied to the gauge body 155 (e.g. via the contact indication generator 324A) and therefore reducing or preventing any damage to the gauge body due to the impact force of collision.

In other examples, the contact indication generator may be disposed on the surface of the cushion. In other words, in examples, the contact indication generator and the traverse arm sandwich the cushion.

When a contact indication is generated, the contact indication is sent to the control means 170. Upon receipt of the contact indication the control means 170 stops the relative movement between the measurement probe 160 and the component 190 (i.e. the relative speed is reduced to zero).

In the present first example of the collision protection apparatus, wherein the roundness measurement instrument is provided with both one or more proximity sensors and one or more contact sensors (in contrast to the second and third examples of the collision protection apparatus—described herein) the two types of sensor may provide a synergistic effect.

In more detail the first contact sensor 320A (taking the first contact sensor 320A as representative of the remaining contact sensors 320B to 320H) has a stopping time (i.e. a delay) defined as the time between contacting the first contact sensor 320A and cessation of relative movement between the component 190 and the measurement probe 160. The distance the probe moves during the stopping time is referred to as the stopping distance. This delay may be due to a number of factors including any of: propagation time of signals between the contact sensor 320 and the control means 170; propagation time of signals between the control means and servos which drive the relative movement (e.g. the servos rotate the rotating mount and/or move the pillar 130 and/or the carriage 140 and/or the traverse arm 150 and/or the gauge body 155); time taken for the servos to stop upon receipt of a signal to do so; et cetera.

As set out above, the movement speed is the relative speed between the measurement probe 160 and the component 190. The movement speed is determined by a proximity signal generated by at least one of the proximity sensors 310.

The cushions of the contact sensors 320A-320H form an outer surface of the contact sensor. In other words, to trigger the contact sensor (e.g. to make the contact sensor to generate a contact signal) an impact force of collision has to be applied to the cushion.

The cushions (e.g. cushion 322A) have a compliance which is the distance through which the cushion can be compressed. For example, a cushion having a thickness of 1 cm which can be compressed to a thickness of 0.6 cm has a compliance of 0.4 cm. In the present example, the compliance of all of the cushions is identical.

The cushions have a stiffness which is selected based on the sensitivity of the contact sensor (e.g. the sensitivity of the contact signal generator). The stiffness is selected so that compression of the cushion triggers the contact sensor (e.g. compression of the cushion triggers the contact signal generator to generate a contact signal).

The cushions are laminar elements e.g. the cushions have a cuboid shape. The cushions are flexible which allows the cushion to conform to the measurement instrument e.g. the cushions can be wrapped around a portion of the gauge body (or e.g. the traverse arm and/or carriage) of the measurement instrument.

In the first example of the collision protection apparatus 300 (having both types of sensor), the control means determines a new movement speed V based on both, the proximity indication from one of the proximity sensors 310A-310D and the compliance of the cushions. The compliance of the cushions may be pre-programmed into the control means or alternatively input by a user (e.g. using an input means such as a keyboard). The new movement speed V is selected so that the product of the new movement speed V and the stopping time T of the contact sensors 320 is less than or equal to the compliance of the cushions. Expressed mathematically:

$$V \cdot T \leq c ; or , V \leq c / T ;$$

Advantageously, the new movement speed is selected so that any contact (e.g. collision) between the roundness measurement apparatus 100 (e.g. the measurement probe thereof 160 or, for example, the gauge body 155 etc.) and the component 190 results in stopping the relative movement therebetween as or before the cushion is maximally compressed. As a result, contact between the component 190 and the roundness measurement instrument 100 is prevented or at least reduced. In other words, a balance can be struck between permitting high speed roundness measurements of components whilst still protecting the components (and roundness measurement instrument) from damage.

The collision protection apparatus 300 described herein with reference to a roundness measurement instrument can instead be used with an optical profiling measurement instrument. The proximity sensors 310 are mounted on the movable frame 230 with the direction of FOV of the proximity sensors 310 in at least one of the R-direction; axial direction (i.e. along the Z-axis); and, in the direction of the measurement probe 260. The contact sensors are mounted on the measurement probe 260. The control means 170 is replaced for the control means 270 of the optical profiling measurement instrument.

### Second Example of the Collision Protection Apparatus

The second example of the collision protection apparatus with the roundness measurement instrument is similar to that described above with reference to the first collision protection apparatus with the roundness instrument, with the exception that the contact sensors are omitted.

Likewise, the second example of the collision protection apparatus with the optical profiling instrument is similar to that described above with reference to the first collision protection apparatus with the optical profiling instrument, with the exception that the contact sensors are omitted.

### Third Example of the Collision Protection Apparatus

The third example of the collision protection apparatus with the roundness measurement instrument is similar to that described above with reference to the first collision protection apparatus with the roundness instrument, with the exception that the proximity sensors are omitted.

Likewise, the third example of the collision protection apparatus with the optical profiling instrument is similar to that described above with reference to the first collision protection apparatus with the optical profiling instrument, with the exception that the proximity sensors are omitted.

### Fourth Example of the Collision Protection Apparatus

The roundness measurement instrument 100 (described above with reference to FIGS. 1A and 1B) is provided with a fourth example of the collision protection apparatus 400 for a measurement instrument. The disclosure also provides a corresponding method of controlling a measurement instrument.

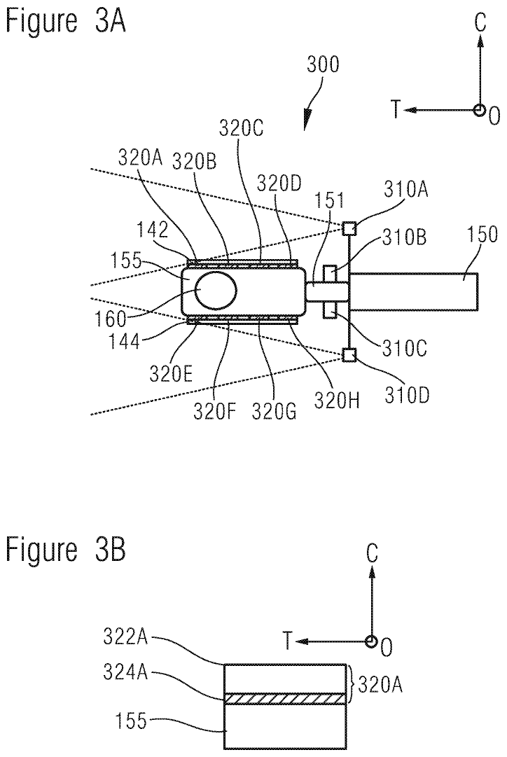

FIG. 4 illustrates a plan view, parallel to the traverse axis, of the traverse arm 150, the bracket 151 the gauge body 155, the measurement probe 160 with the fourth example of the collision protection apparatus 400.

The collision protection apparatus 400 comprises: a control means 170; a first distance sensor 410A.

FIG. 4 shows the set of orthogonal axes, namely, the carriage axis C in the plane of the page, the traverse axis T in the plane of the page, and the orthogonal axis O which points in a direction out of, and perpendicular to, the page.

In the present example, the control means 170 of the collision protection apparatus 400 is the same control means 170 for controlling the roundness measurement instrument 100.

The control means 170 is configured to receive distance signals from the distance sensor 410A e.g. the control means 170 is connected (e.g. communicatively with wires or wirelessly) to the distance sensor 410.

In other examples, the control means of the collision protection apparatus may be separate from the control means for controlling the roundness measurement instrument (described in more detail below).

The first distance sensors 410A is connected to the traverse arm 150. The first distance sensor 410A is disposed on an upper side of the traverse arm 150. The first distance sensor 410A may be a lidar sensor (described herein).

In examples, the distance sensor may be provided with a housing. Each housing encapsulates (e.g. surrounds at least part of) the distance sensors. In examples, at least part of the housing is transparent to the radiation used by the distance sensor (e.g. transparent to the frequency (or frequencies) of light used by a lidar distance sensor) e.g. the housing comprises a coverglass window to permit light to pass therethrough.

The housing comprises a fixture configured to permit the housing to be secured to the measurement instrument (e.g. on the measurement probe and/or the traverse arm and/or the carriage and/or the pillar). For example, the fixture may comprise at least one of: an adhesive compound; double sided adhesive substrate; screws and bolts; hooks and/or loops (with corresponding hooks and/or loops provided on the measurement instrument); a strap; et cetera.

The first distance sensor 410A is connected to control means 170 i.e. so that distance signals generated by the distance sensor 410A is sent to the control means 170.

The distance sensor 410A has a field of view (FOV) which is a right circular cone wherein the vertex of said cone is located at the distance sensor 410A. The cone has a longitudinal axis which passes through the vertex of the cone extending perpendicularly to the base of the cone. The longitudinal axis of the cone is indicative of the direction of the FOV of the distance sensor. In the present example, the direction of the FOV of the first distance sensor 410A is parallel to the traverse axis T.

In examples, each of the first distance sensor may be a lidar detector having an emitter and a detector spaced slightly apart (e.g. ˜3 mm) wherein each emitter and detector has its own FOV. In such examples, there may be a small (e.g. ˜10 mm) exclusion zone and an effective FOV for the sensor where the emitter and detector FOV cones overlap.

The first distance sensor 410A generates a distance signal in the event that an item (e.g. the component 190) is disposed within the FOV of the first distance sensor 410A. In the present example, a distance signal is generated by the first distance sensor 410A comprises an indication of the distance between the first distance sensor 410A and the item in the FOV of the distance sensor. The generated distance signal is sent to the control means 170.

In examples, the distance sensor may comprise a plurality of sensor units. The sensor units each provide directional sensing for sensing distance in a particular direction from the sensor. In such examples, a first distance sensor may comprise a first sensor unit, a second sensor unit and a third sensor unit. In such examples, the first sensor unit has a direction of FOV aligned with the carriage axis C, the second sensor unit has a direction of FOV aligned with the traverse axis T, and the third sensor unit has a direction of FOV aligned with the orthogonal axis O.

Alternatively, the first distance sensor may comprise a fourth sensor unit and a fifth sensor unit. The direction of FOV of the fourth sensor and fifth sensor may be parallel but in different directions e.g. the fourth sensor having a direction of FOV in a positive carriage direction (+C) and the fifth sensor have a direction of FOV in a negative carriage direction (−C).

For example, each of the sensor units may be Lidar sensor.

The control means 170 is configured to define a first threshold region around the component based on the first distance signal. In the present example, the first threshold region is delimited by a first threshold surface wherein said first threshold surface is a cylinder with radius of a first distance centred on the rotational axis X of the rotatable mounting 120.

The first distance is based on the first distance signal obtained by the first distance sensor. In the present example, the first threshold distance is a radius centred on the rotational axis X, wherein the first threshold distance is the distance indicated by the first distance signal plus a first offset.

The control means 170 is configured to reduce the movement speed in the event that the measurement probe enters the first threshold region. In the present example, the movement speed is reduced to half of the maximum movement speed.

The control means 170 is configured to determine if the measurement probe is within the first threshold region based on a position signal wherein the position signal is indicative of the position of the measurement probe relative to the component.

The position signal is provided by the control means 170 of the measurement instrument. The position signal comprises given displacements of the pillar 130, the carriage 140 and the traverse arm 150 from respective reference locations which are obtained by the control means.

In examples, the first distance sensor is also configured to provide a second distance signal from the first distance sensor disposed in a second location, wherein the second distance signal is indicative of the distance between the component and the first distance sensor disposed in the second location. In the present example, the first distance sensor is moved in the C direction to obtain the second distance signal i.e. by moving the carriage 140 up or down the pillar 130.

In such examples, the control means is configured to define the first threshold region around the component based on the first distance signal and the second distance signal. For example, the control means may obtain a first average distance by averaging the distances indicated by the first distance signal and the second distance signal. The first threshold region may then be determined by the control means based on the first average distance e.g. the first threshold region may be delimited by a cylinder with a radius centred on the rotational axis X wherein said radius has a length of the first average distance plus a first offset distance. In a likewise manner, a second threshold region may be determined based on the first average distance but with a second offset distance which is less than the first offset distance.

The control means may obtain distance measurements from a plurality of positions along the C axis. The control means can generate a map of the component surface (i.e. a profile of the surface of the component in the C-T plane). The map comprises a plurality of distance measurements in the T direction between the surface of the distance sensor. In such examples, the first threshold region may be defined as a modified map wherein the points on the surface of the first threshold region are defined by the map plus a fixed offset distance from the radius. In this manner, a more detailed first threshold region is provided.

In examples, the distance sensor may be moved continuously in a given direction e.g. along the C axis and generate distance signals on a continuous basis to thereby permit a profile of the surface of the component to be determined. For example, the first distance sensor 410A sends a distance signal to the control means 170 at a selected sampling rate. For example, the carriage 140, to which the first distance sensor 410A is attached, is moved along the C axis between a first position and a second position whilst the distance sensor is sampling.

The sampling rate may be one distance signal sent to the control means every 10 milliseconds e.g. 100 proximity indications per second. In examples, the control means may store the distance between the measurement probe 160 and the first distance sensor 410A e.g. so that the control means can determine the distance between the measurement probe and the surface of the component based on the distance indicated by the distance signal which is indicative of the distance between the distance sensor and the surface of the component.

In examples, the control means may determine a first limit of the movement speed (e.g. a movement speed limit) in the event that the measurement probe 160 enters the first threshold region. Similarly, the control means may determine a second limit of the movement speed in the event that the measurement probe 160 enters the second threshold region (i.e, wherein the second limit is lower than the first limit).

In examples, a second distance sensor may be provided. The second distance sensor may operate in the same manner as the first sensor. In such examples, corresponding distance signals refer to a distance signal from the first distance sensor and a distance signal from the second distance sensor obtained for a given displacement of the measurement probe (e.g. given displacements of the pillar, the carriage and the traverse arm from respective reference locations). The distance indicated by distance signals from the first distance sensor and the second distance sensor for a given arrangement of the measurement instrument may be averaged to obtain an average distance. Subsequently, the control means may define a threshold region based on this average distance e.g. in a similar manner to that defined for a single distance sensor.

In such examples, the second distance sensor, the second distance sensor disposed in a second location. For example, the second distance sensor may be connected to the carriage and disposed on a bottom side thereof i.e. so that the first distance sensor is disposed on a top side of the carriage and the second distance sensor is disposed on a bottom side of the carriage.

Additional distance sensors may be provided and may operate in a similar manner as the first and second distance sensors described herein.

In examples, the fourth example of a collision protection apparatus comprises one or more contact sensors such as those described herein in reference to other examples of the collision protection apparatus. In such examples, any of the one or more contact sensors is configured to sense contact between the contact sensor (disposed on part of the measurement instrument). For example, the contact sensor may generate a contact signal which is sent to the control means.

In examples comprising one or more contact sensors, the control means is configured to stop movement of the measurement probe in the event that a contact sensor indicates contact between the component and the measurement instrument (e.g. in the event that the control means receives a contact signal from the one or more contact sensors, then the control means ceases movement of the measurement probe relative to the component). Stopping the movement of the measurement probe comprises stopping movement of the pillar 130 (i.e. in the T direction), movement of the carriage 140 (i.e. in the C direction), movement of the traverse arm 150 (i.e. in the T direction), movement of the measurement probe 160 (i.e. in the O direction), and movement of the component 190 (i.e. rotation of the component around the rotational axis X).

In examples, the first distance sensor is fixedly attached to the pillar i.e. the first distance sensor does not move relative to the pillar. In examples wherein a second distance sensor is provided the second distance sensor may also be fixedly attached to the pillar.

In examples, the one or more distance sensors may be configured to determine the distance between the component and the distance sensor or pillar. For example, this may permit the part of the component which protrudes furthest in a radial direction from the rotational axis X to be determined. In such examples, a first threshold distance may be based on this distance e.g. the first threshold distance may be the radius of the furthest protruding part of the component plus an offset distance (e.g. 10 cm). The first threshold region is a cylinder centred on the rotational axis X having a radius of the first threshold distance. A second threshold distance may be defined in a similar manner with an offset distance less than the first offset distance (e.g. 5 cm).

### Proximity Method

A method 500 of controlling the roundness measurement instrument 100 for avoiding collisions between the measurement instrument 100 and a component 190 to be measured is provided.

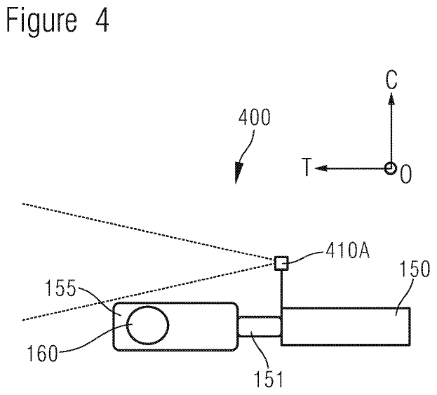

FIG. 5 illustrates a flowchart depicting the method 500. The method 500 comprises the following steps:

Operating, S501, the proximity sensor 310A for sensing proximity between the measurement probe 160 and the component 190 and monitoring the proximity while moving the measurement probe 160 relative to the component 190 at a movement speed.

Reducing, S502, the movement speed in the event that proximity sensor 310A indicates that the measurement probe 160 is within a threshold distance of the component 190. For example, the indicated proximity is compared (e.g. by a computer and/or a control means) to a stored threshold distance.

It will be appreciated that the same method can be used to control the optical profiling measurement instrument 200 in the same manner.

### Contact Method

A method 600 of controlling the roundness measurement instrument 100 for reducing or preventing damage due to collisions between the measurement instrument 100 and a component 190 to be measured is provided.

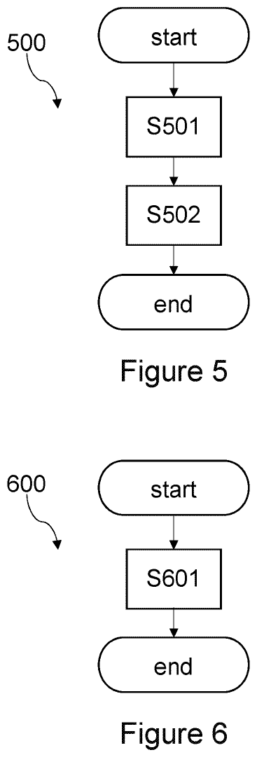

FIG. 6 illustrates a flowchart depicting the method 600. The method 600 comprises the following steps:

Stopping, S601, movement of the measurement probe 160 in the event that a contact sensor 320A indicates that the measurement probe 160 is in contact with the component 190.

It will be appreciated that the same method can be used to control the optical profiling measurement instrument 200 in the same manner.

### Pre-Scan Method

A method 700 of controlling the roundness measurement instrument 100 for reducing or preventing damage due to collisions between the measurement instrument 100 and a component 190 to be measured is provided.

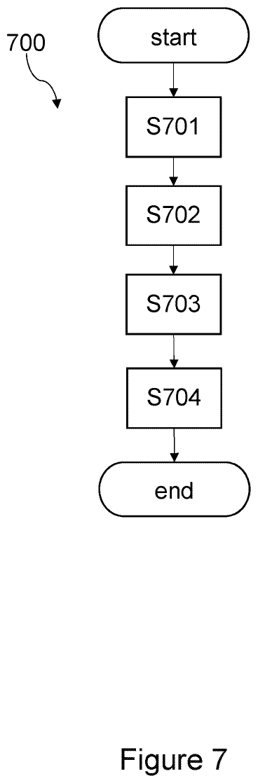

FIG. 7 illustrates a flowchart depicting the method 700. The method 700 comprises the following steps:

Obtaining, S701, a first distance signal from a first distance sensor wherein the first distance signal is indicative of the distance between the component and the first distance sensor.

Defining, S702, a first threshold region around the component based on the first distance signal.

Determining, S703, if the measurement probe is within the first threshold region based on a position signal wherein the position signal is indicative of the position of the measurement probe relative to the component.

Reducing, S704, the movement speed to a first movement speed in the event that the measurement probe is within the first threshold region.

It will be appreciated that the same method can be used to control the optical profiling measurement instrument 200 in the same manner.

Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

Certain features of the methods described herein may be implemented in hardware, and one or more functions of the apparatus may be implemented in method steps. It will also be appreciated in the context of the present disclosure that the methods described herein need not be performed in the order in which they are described, nor necessarily in the order in which they are depicted in the drawings. Accordingly, aspects of the disclosure which are described with reference to products or apparatus are also intended to be implemented as methods and vice versa. The methods described herein may be implemented in computer programs, or in hardware or in any combination thereof. Computer programs include software, middleware, firmware, and any combination thereof. Such programs may be provided as signals or network messages and may be recorded on computer readable media such as tangible computer readable media which may store the computer programs in non-transitory form. Hardware includes computers, handheld devices, programmable processors, general purpose processors, application specific integrated circuits (ASICs), field programmable gate arrays (FPGAs), and arrays of logic gates.

Any processors used in the computer system (and any of the activities and apparatus outlined herein) may be implemented with fixed logic such as assemblies of logic gates or programmable logic such as software and/or computer program instructions executed by a processor. The computer system may comprise a central processing unit (CPU) and associated memory, connected to a graphics processing unit (GPU) and its associated memory. Other kinds of programmable logic include programmable processors, programmable digital logic (e.g., a field programmable gate array (FPGA), a tensor processing unit (TPU), an erasable programmable read only memory (EPROM), an electrically erasable programmable read only memory (EEPROM), an application specific integrated circuit (ASIC), or any other kind of digital logic, software, code, electronic instructions, flash memory, optical disks, CD-ROMs, DVD ROMs, magnetic or optical cards, other types of machine-readable mediums suitable for storing electronic instructions, or any suitable combination thereof. Such data storage media may also provide the data store of the computer system (and any of the apparatus outlined herein).

Other examples and variations of the disclosure will be apparent to the skilled addressee in the context of the present disclosure.

In examples, the movement speed Vₘ refers to the total speed in the orthogonal direction (i.e. parallel to the O axis shown in FIG. 1) between the measurement probe and the component.

In the present examples, the contact sensors comprise force sensing resistors (FSRs). An FSR is an element having a resistance wherein said resistance changes in response to an applied impact force of collision (or, for example, an applied pressure or mechanical stress). In examples wherein the contact sensors comprise contact indication generators, then the contact indication generator may comprise an FSR. In other examples, the contact sensors may be something other than an FSR such as a button switch.

In the present example, the proximity sensors comprise Lidar sensor. Example Lidar sensors comprise a laser to and light detector configured to emit laser light and detect the time taken for the light to be reflected to the light detector. The time taken between emission of the laser light and detection at the detector is indicative of the distance travelled by the laser light from the laser to the object the light is reflected from and to the detector. In other examples, the proximity sensors may be something other than Lidar sensors such as, for example, an ultrasound sensor.

In examples, the control means for the measurement instrument comprises a signal interface for connecting the control means to receive said proximity signals and/or said contact sensing signals.

In examples, the control means of the collision protection apparatus may be separate from a control means for the measurement instrument. In such examples, the control means for the collision protection apparatus is configured to receive proximity signals and/or contact signals from proximity sensors and contact sensors respectively. Put simply, the control means for the collision protection apparatus may be separate from acts as an intermediary between the sensors and the controller.

In the case of receiving a proximity signal, the control means for the collision protection apparatus may determine that the movement speed should be reduced. If such a determination is made, then the control means for the collision protection apparatus generates a change speed signal (e.g. a signal indicative of a new movement speed which the measurement instrument should move the measurement probe relative to the component). The change speed signal is sent to the control means for the measurement instrument which then adjusts the relative speed between the component and measurement instrument to that speed indicated by the change speed signal.

In the case of receiving a contact signal, the control means either: forwards this contact signal on to the control means of the measurement instrument; or, generates a stop signal which is sent to the control means of the measurement instrument. In any case, upon receipt of the signal, the control means of the measurement instrument ceases relative movement of between the component and the measurement probe (i.e. the movement speed is set to zero).

In examples, the control means controls a movement speed limit and not the movement speed per se. In other words, the control means determines a maximum possible movement speed based on a proximity signal (i.e. the movement speed limit) but that the selected movement speed between the measurement probe and the component (e.g. selected by a user or a pre-programmed operational mode of the measurement instrument) is below the maximum possible movement speed.

In examples wherein the control means controls the movement speed limit, the movement speed limit may be selected proportional to the distance between the measurement instrument and the component (e.g. indicated by the proximity signal). In examples wherein the control means controls the movement speed limit, the movement speed limit may be selected based on the stopping distance of the measurement probe (e.g. in response to a command to stop) at that speed limit. For example, the movement speed limit may be selected so that if the actual movement speed where identical to the movement speed limit, then the movement speed could be ceased (e.g. in response to a signal to do so) before the measurement probe and the component collided. In other words, the movement speed limit may be selected so that the stopping distance would not be greater than the distance between the measurement probe and the component.

In examples, the control means limits the movement speed so that the distance between the measurement probe and the component is greater than the stopping distance of the measurement probe. The stopping distance is the distance the measurement probe moves through in response to a command (e.g. a signal) to cease the relative movement between the measurement probe and the component.

In examples, the collision protection apparatus (and the other aspects of the disclosure, for example, the methods, and apparatus described herein) the proximity signal is indicative of the proximity of a part of the measurement apparatus (e.g. the measurement probe and/or the traverse arm and/or the carriage assembly and/or the pillar) to the component and the control means is configured to monitor the proximity signal and to reduce the movement speed (or movement speed limit) in the event that the proximity signal indicates that the part of the measurement apparatus (e.g. said measurement probe and/or said traverse arm and/or said carriage assembly and/or said pillar) is within a threshold distance of the component.

In examples, the component may be referred to as the workpiece. In examples, the measurement probe may be referred to as the measurement gauge.

In examples, the roundness measurement instrument may be configured to measure at least one of: roundness; flatness; cylindricity; surface straightness; velocity; measure surface finish; and/or may be configured to perform harmonic analysis.

In examples, the roundness measurement instrument may be configured to perform contact measurements e.g. contacting the measurement probe to the surface of the component to be measured.

Herein measurement instruments may also be referred to as metrological instrument. Herein measurement instruments are described as measuring a component. Said component may be referred to as a test piece or a work piece.

In examples described herein, lidar sensors measure the shortest distance between the sensor and an object in its field of view FOV.

1. A collision protection apparatus for a measurement instrument, the measurement instrument comprising:
a rotatable mounting for rotating a component to be measured;
a measurement probe configured to perform a surface measurement of the component as the component rotates on the rotatable mounting;
move relative to the component at a movement speed;
the collision protection apparatus comprising a contact sensor for sensing contact with the component; and,
a control means configured to stop movement of the measurement probe in the event that the contact sensor indicates contact with the component.

2. The collision protection apparatus of claim 1 wherein the control means is configured to reduce a limit of the movement speed based on the proximity signal so that the limit gets lower as the measurement probe moves closer to the component.

3. The collision protection apparatus of claim 2 wherein the limit of movement speed is selected based on the proximity of the measurement probe to the component so that the distance between the component and the measurement probe is not less than a stopping distance of the measurement probe.

4. The collision protection apparatus of claim 1, 2 or 3 comprising a proximity sensor, wherein the proximity sensor is provided in a housing, which encapsulates the proximity sensor and which is securable to the measurement probe.

5. The collision protection apparatus of claim 4 wherein the housing of the proximity sensor comprises a fixture for securing the proximity sensor to the measurement probe.

6. The collision protection apparatus of claim 4 or 5 wherein the proximity sensor comprises a plurality of sensor units, wherein the sensor units each provide directional sensing for sensing proximity in a particular direction from the sensor.

7. The collision protection apparatus of any preceding claim wherein the measurement instrument comprises a roundness measuring instrument and wherein:
the measurement probe is configured to perform a first roundness measurement at a first measurement site on the component and to move along a trajectory at the movement speed to a second measurement site on the component for performing a second roundness measurement.

8. The collision protection apparatus of claim 7 wherein the measurement probe is mounted on a traverse arm for movement of the measurement probe in a traverse direction, and the traverse arm is mounted on a carriage translatable along a pillar in a carriage direction, perpendicular to the traverse direction.

9. The collision protection apparatus of claim 8 as dependent upon claim 6 comprising a mounting for mounting a first one of said proximity sensor units on a first side of the measurement probe spaced from the measurement probe in the carriage direction and directed for sensing proximity in the traverse direction.

10. The collision protection apparatus of claim 9 wherein a second one of said proximity sensor units is provided on the mounting on a second side of the measurement probe, opposite to the first side, and spaced from the measurement probe in the carriage direction.

11. The collision protection apparatus of any preceding claim, wherein:
the rotatable mounting defines an axial direction corresponding the rotational axis of the mounting and a radial direction perpendicular to the axial direction;
the measurement probe is coupled to a movable frame wherein the frame is movable in the axial direction and the radial direction relative to the rotatable mounting;
the probe is rotatable in a tilt plane defined by the radial direction and the axial direction.

12. The collision protection apparatus of claim 11 as dependent upon claim 6, wherein a first one of said proximity sensor units is mounted on a first side of the movable frame directed for sensing proximity in the radial direction.

13. The collision protection apparatus of claim 12, wherein a second one of said proximity sensor units on a second side of the movable frame directed for sensing proximity in the axial direction.

14. The collision protection apparatus of claim 13 wherein a third one of said proximity sensor units is mounted on a third side of the movable frame directed for sensing proximity in a direction oblique or perpendicular to the tilt plane.

15. The collision protection apparatus of any preceding claim wherein the contact sensor comprises a cushion for absorbing an impact force of collision between the measurement sensor and the component.

16. The collision protection apparatus of any preceding claim wherein the contact sensor comprises a cushion for absorbing an impact force of collision between a traverse arm and the component.

17. The collision protection apparatus of any preceding claim wherein the contact sensor comprises a cushion for absorbing an impact force of collision between the movable frame and the component.

18. The collision protection apparatus of any of claims 15 to 17 wherein the cushion has a stiffness selected based on a sensitivity of the contact sensor, such that compression of the cushion triggers the contact sensor.

19. The collision protection apparatus of any of claims 15 to 18, wherein the cushion comprises a laminar element configured to be secured to a surface of the measurement probe.

20. The collision protection apparatus of claim 19 wherein the laminar element is flexible to enable the cushion to conform to the measurement probe.

21. The collision protection apparatus of any of claims 15 to 20 wherein the contact sensor comprises a force sensing resistor.

22. The collision protection apparatus of claim 21 wherein the contact sensor is at least one of (i) disposed at a surface of the cushion, and (ii) integrated with the cushion.

23. The collision protection apparatus of any preceding claim wherein the proximity sensor comprises an optical sensor, such as lidar.

24. A method of controlling a measurement instrument for avoiding collisions between a measurement probe of the measurement instrument and a to be measured, wherein the measurement instrument comprises a rotatable mounting for rotating a component for measurement, the measurement instrument is configured to control the measurement probe to perform a surface measurement of the component as the component rotates on the rotatable mounting and move relative to the component at a movement speed;
the method comprising:
operating a proximity sensor for sensing proximity between the measurement probe and the component, monitoring the proximity while moving the measurement probe relative to the component at a measurement speed; and
reducing the movement speed in the event that proximity sensor indicates that the measurement probe is within a threshold distance of the component.

25. The method of claim 24 comprising stopping movement of the measurement probe in the event that a contact sensor indicates that the measurement probe is in contact with the component.

26. A computer program product configured to program a controller of a measurement instrument to perform the method of claim 24 or claim 25, wherein the controller of the measurement instrument comprises a signal interface for connecting the controller to receive said proximity signals and/or said contact sensing signals.

27. A kit for adapting a measurement instrument to provide collision protection, the kit comprising a proximity sensor configured to provide a proximity signal indicative of the proximity of the measurement probe to the component and a contact sensor for sensing contact with the component; and the kit further comprising the computer program product of claim 26.

28. The kit of claim 27 wherein the proximity sensor is provided in a housing, which encapsulates the proximity sensor and which is securable to the measurement probe, for example wherein the housing of the proximity sensor carries a fixing means for securing the proximity sensor to the measurement probe.

29. The kit of claim 27 or 28 wherein the contact sensor comprises a cushion, provided as a flexible laminar element which is conformable to a surface of the measurement probe, for example wherein the cushion is configured to adhere to the measurement probe.

30. A method of adapting a measurement instrument to provide collision protection for collisions between a measurement probe and a component, wherein the measurement instrument comprises:
rotatable mounting for rotating a component for measurement;
a measurement probe configured to:
perform a surface measurement of the component as the component rotates on the rotatable mounting;
move relative to the component at a movement speed;
the method comprising at least one of:
providing a proximity sensor wherein the proximity sensor is:
configured to provide a proximity signal indicative of the proximity of the measurement probe to the component; and,
operable to reduce the movement speed in the event that the proximity signal indicates that the measurement probe is within a threshold distance of the component;
disposing, on a measurement probe, a contact sensor wherein the contact sensor is:
configured to sense contact between the contact sensor and the measurement probe; and,
operable to stop movement of the measurement probe in the event that the contact sensor indicates contact with the component.

31. A measurement instrument for performing measurements of a component, the measurement instrument comprising:
a rotatable mounting for rotating a component for measurement;
a measurement probe configured to:
perform a surface measurement of the component as the component rotates on the rotatable mounting;
move relative to the component at a movement speed;
a collision protection apparatus comprising:
a proximity sensor configured to provide a proximity signal indicative of the proximity of the measurement probe to the component;
a control means configured to monitor the proximity signal and to reduce the movement speed in the event that the proximity signal indicates that the measurement probe is within a threshold distance of the component; and,
a contact sensor wherein the control means is configured to stop relative movement between the measurement probe and the component in the event that the contact sensor indicates contact with the component.

32. A method of controlling a measurement instrument (100; 200) for avoiding collisions between the measurement instrument and a component (190; 290) to be measured, wherein the measurement instrument comprises a rotatable mounting (120; 220) for rotating a component (190; 290) for measurement, the measurement instrument (100) is configured to control the measurement probe (160; 260) to perform a surface measurement of the component (190; 290) as the component rotates on the rotatable mounting (120; 220) and the measurement probe moves relative to the component at a movement speed, the method comprising:
obtaining a first distance signal from a first distance sensor wherein the first distance signal is indicative of the distance between the component and the first distance sensor;
defining a first threshold region around the component based on the first distance signal;
reducing the movement speed to a first movement speed in the event that the measurement probe is within the first threshold region.

33. The method of claim 32, wherein:
the first distance signal is obtained from the first distance sensor in a first location wherein the first distance signal is indicative of the distance between the component and the first distance sensor in the first location; and,
the method further comprising:
obtaining a second distance signal from the first distance sensor in a second location wherein the second distance signal is indicative of the distance between the component and the first distance sensor in the second location;
defining the first threshold region around the component based on the first distance signal and the second distance signal.

34. The method of claim 32, comprising:
moving the first distance sensor from the first location to the second location.

35. The method of claim 32, wherein:
the first distance signal is obtained from the first distance sensor in a first location wherein the first distance signal is indicative of the distance between the component and the first distance sensor in the first location; and,
the method further comprising:
obtaining a second distance signal from a second distance sensor in a second location, wherein the second distance signal is indicative of the distance between the component and the second distance sensor in the second location;
defining the first threshold region around the component based on the first distance signal and the second distance signal.

36. The method of any of claims 32 to 35 comprising:
determining if the measurement probe is within the first threshold region based on a position signal wherein the position signal is indicative of the position of the measurement probe relative to the component.

37. The method of any claim 36, wherein:
the position signal is provided by a control means of the measurement instrument.

38. The method of any of claims 32 to 37, comprising:
stopping movement of the measurement probe in the event that a contact sensor indicates contact between the component and the measurement instrument.

39. A collision protection apparatus for a measurement instrument, the measurement instrument comprising:
a rotatable mounting for rotating a component to be measured;
a measurement probe configured to:
perform a surface measurement of the component as the component rotates on the rotatable mounting; and,
move relative to the component at a movement speed;
the collision protection apparatus comprising:
a first distance sensor, wherein the first distance sensor is configured to provide a first distance signal indicative of the distance between the component and the first distance sensor;
a control means configured to:
define a first threshold region around the component based on the first distance signal;
reduce the movement speed in the event that the measurement probe enters the first threshold region.

40. The collision protection apparatus of claim 39, wherein:
the first distance signal is obtained from the first distance sensor disposed in a first location wherein the first distance signal is indicative of the distance between the component and the first distance sensor disposed in the first location; and,
wherein:
the first distance sensor is configured to:
provide a second distance signal from the first distance sensor disposed in a second location, wherein the second distance signal is indicative of the distance between the component and the first distance sensor disposed in the second location;
the control means is configured to:
define the first threshold region around the component based on the first distance signal and the second distance signal.

41. The collision protection apparatus of claim 40, wherein:
the first distance sensor is movable from the first location to the second location.

42. The collision protection apparatus of claim 40, wherein:
the first distance signal is obtained from the first distance sensor distance in a first location wherein the first distance signal is indicative of the distance between the component and the first distance sensor disposed in the first location; and,
the collision protection apparatus further comprising:
a second distance sensor, wherein the second distance sensor is configured to provide a second distance signal indicative of the distance between the component and the second distance sensor disposed in a second location; and,
the control means is configured to:
define the first threshold region around the component based on the first distance signal and the second distance signal.

43. The collision protection apparatus of any of claims 40 to 42, wherein:
the control means is configured to
define if the measurement probe is within the first threshold region based on a position signal wherein the position signal is indicative of the position of the measurement probe relative to the component.

44. The collision protection apparatus of claim 43, wherein:
the position signal is provided by a control means of the measurement instrument.

45. The collision protection apparatus of any of claims 40 to 44, wherein:
the control means is configured to:
stop movement of the measurement probe in the event that a contact sensor indicates contact between the component and the measurement instrument.

46. A collision protection apparatus for a measurement instrument the measurement instrument comprising:
a rotatable mounting for rotating a component to be measured;
a measurement probe configured to:
perform a surface measurement of the component as the component rotates on the rotatable mounting; and,
move relative to the component at a movement speed;
the collision protection apparatus comprising:
a proximity sensor configured to provide a proximity signal indicative of the proximity of the measurement probe to the component; and
a control means configured to monitor the proximity signal and to reduce the movement speed in the event that the proximity signal indicates that the measurement probe is within a threshold distance of the component.

47. The collision protection apparatus of claim 46, comprising:
a contact sensor wherein the control means is configured to stop relative movement between the measurement probe and the component in the event that the contact sensor indicates contact with the component.
